(19) United States
(12) Patent Application Publication
(10) Pub. No.: US 2004/0165728 A1
(43) Pub. Date: Aug. 26, 2004

(54) Limiting service provision to group members

(75) Inventors: Stephen James Crane, Bristol (GB); Liqun Chen, Bristol (GB)

Correspondence Address: HEWLETT-PACKARD COMPANY, Intellectual Property Administration, P.O. Box 272400, Fort Collins, CO, 80527-2400, US

(73) Assignee: Hewlett-Packard Development Company, L.P.

(21) Appl. No.: 10/782,079

(22) Filed: Feb. 19, 2004

(30) Foreign Application Priority Data
Feb. 22, 2003 (GB) 0304054.0
May 29, 2003 (GB) 0312236.3

(51) Int. Cl. H04L 9/00

(52) U.S. Cl. 380/279

(57) ABSTRACT

A method and system is provided for enabling a service provider to limit service access to registered members of a group. The service provider encrypts data using an encryption key string and public data provided by the membership authority, and provides the encrypted data to a party wanting a particular service. To receive the service, the party must decrypt the encrypted data using a decryption key that has been obtained from a group membership authority preferably subsequent to the encrypted data being received by the party. The membership authority provides the decryption key only if the party is a group member, the authority generating the decryption key using the encryption key string and private data used in deriving the public data.

### FIELD OF THE INVENTION

The present invention relates to a method and system for enabling a service provider to limit service access to members of a group whose membership is regulated by a body in accordance with predetermined membership requirements.

As used herein, references to the provision of a service are to be broadly understood to include, without limitation, transactional services, information services and services that provide access to a data component such as software or digital media.

### BACKGROUND OF THE INVENTION

Many service providers require potential users to identify themselves before service delivery is effected; this is generally done in order for the service provider to decide whether the user can be “trusted” in some way or other in respect of the service (for example, either regarding how the service is used or in respect of payment for the service).

However, such disclosure of identity raises privacy concerns which must be balanced against the service provider's concerns regarding provision of a service to an anonymous user.

One way of dealing with this conflict is for the service provider to provide its service to anyone who is a member of an organisation where such membership itself provides the service provider with sufficient trust in the person requesting service. In the physical world, membership of an organisation is, for example, proved by possession of a membership card. In the electronic world, it is possible to use existing PKI technology, and other techniques such as group signatures, to achieve the same goal. However, these known techniques are generally inefficient and expensive in terms of processing time and communications bandwidth.

It is an object of the present invention to provide an improved way for a service provider to limit service to members of a group.

As will become clear hereinafter, the present invention is in part based on the appreciation that Identifier-Based Encryption (IBE) has certain properties that can be adapted for use in limiting service provision to members of a group.

Identifier-Based Encryption (IBE) is an emerging cryptographic schema. In this schema (see FIG. 1 of the accompanying drawings), a data provider 10 encrypts payload data 13 using both an encryption key string 14, and public data 15 provided by a trusted authority 12. This public data 15 is derived by the trusted authority 12 using private data 17 and a one-way function 18. The data provider 10 then provides the encrypted payload data <13> to a recipient 11 who decrypts it, or has it decrypted, using a decryption key computed by the trusted authority 12 in dependence on the encryption key string and its own private data.

A feature of identifier-based encryption is that because the decryption key is generated from the encryption key string, its generation can be postponed until needed for decryption.

Another feature of identifier-based encryption is that the encryption key string is cryptographically unconstrained and can be any kind of string, that is, any ordered series of bits whether derived from a character string, a serialized image bit map, a digitized sound signal, or any other data source. The string may be made up of more than one component and may be formed by data already subject to upstream processing. In order to avoid cryptographic attacks based on judicious selection of a key string to reveal information about the encryption process, as part of the encryption process the encryption key string is passed through a one-way function (typically some sort of hash function) thereby making it impossible to choose a cryptographically-prejudicial encryption key string. In applications where defence against such attacks is not important, it would be possible to omit this processing of the string.

Typically, the encryption key string serves to “identify” the intended message recipient and the trusted authority is arranged to provide the decryption key only to this identified intended recipient. This has given rise to the use of the label “identifier-based” or “identity-based” generally for cryptographic methods of the type under discussion. However, as will be seen hereinafter, the string may serve a different purpose to that of identifying the intended recipient. Accordingly, the use of the term “identifier-based” or “IBE” herein in relation to cryptographic methods and systems is to be understood simply as implying that the methods and systems are based on the use of a cryptographically unconstrained string whether or not the string serves to identify the intended recipient. Generally, in the present specification, the term “encryption key string” or “EKS” is used rather than “identity string” or “identifier string”; the term “encryption key string” may also used in the shortened form “encryption key” for reasons of brevity.

A number of IBE algorithms are known and FIG. 3 indicates, for three such algorithms, the following features, namely:

the form of the encryption parameters 5 used, that is, the encryption key string and the public data of the trusted authority (TA);

the conversion process 6 applied to the encryption key string to prevent attacks based on judicious selection of this string;

the primary encryption computation 7 effected;

the form of the encrypted output 8.

The three prior art IBE algorithms to which FIG. 3 relates are:

Quadratic Residuosity (QR) method as described in the paper: C. Cocks, “An identity based encryption scheme based on quadratic residues”, Proceedings of the 8^{th} IMA International Conference on Cryptography and Coding, LNCS 2260, pp 360-363, Springer-Verlag, 2001. A brief description of this form of IBE is given hereinafter.

Bilinear Mappings p using, for example, a modified Tate pairing t or modified Weil pairing e for which:

p: G₁×G₁→G₂

where G₁ and G₂ denote two algebraic groups of prime order q and G₂ is a subgroup of a multiplicative group of a finite field. For the Tate pairing an asymmetric form is also possible:

p: G₁×G₀→G₂

where G₀ is a further algebraic group the elements of which are not restricted to being of order q. Generally, the elements of the groups G₀ and G₁ are points on an elliptic curve though this is not necessarily the case. A description of this form of IBE method, using modified Weil pairings is given in the paper: D. Boneh, M. Franklin—“Identity-based Encryption from the Weil Pairing” in Advances in Cryptology—CRYPTO 2001, LNCS 2139, pp. 213-229, Springer-Verlag, 2001.

RSA-Based methods The RSA public key cryptographic method is well known and in its basic form is a two-party method in which a first party generates a public/private key pair and a second party uses the first party's public key to encrypt messages for sending to the first party, the latter then using its private key to decrypt the messages. A variant of the basic RSA method, known as “mediated RSA”, requires the involvement of a security mediator in order for a message recipient to be able to decrypt an encrypted message. An IBE method based on mediated RSA is described in the paper “Identity based encryption using mediated RSA”, D. Boneh, X. Ding and G. Tsudik, 3rd Workshop on Information Security Application, Jeju Island, Korea, Aug, 2002.

In all of the above cases, the decryption key is generated by a trusted authority in dependence on the encryption key string.

A more detailed description of the QR method is given below with reference to the entities depicted in FIG. 1 and using the same notation as given for this method in FIG. 3. In the QR method, the trust authority's public data 15 comprises a value N that is a product of two random prime numbers p and q, where the values of p and q are the private data 17 of the trust authority 12. The values of p and q should ideally be in the range of 2⁵¹¹ and 2⁵¹² and should both satisfy the equation: p, q≡3 mod 4. However, p and q must not have the same value. Also provided is a hash function # which when applied to a string returns a value in the range 0 to N−1.

Each bit of the user's payload data 13 is then encrypted as follows:

The data provider 10 generates random numbers t₊ (where t₊ is an integer in the range [0, 2^{N}]) until a value of t₊ is found that satisfies the equation jacobi(t₊,N)=m′, where m′ has a value of −1 or 1 depending on whether the corresponding bit of the user's data is 0 or 1 respectively. (As is well known, the jacobi function is such that where x²≡#mod N the jacobi (#, N)=−1 if x does not exist, and =1 if x does exist). The data provider 10 then computes the value:

s₊≡(t₊+K/t₊)mod N

where: s₊ corresponds to the encrypted value of the bit m′ concerned, and

K=#(encryption key string)

Since K may be non-square, the data provider additionally generates additional random numbers t (integers in the range [0, 2^{N})) until one is found that satisfies the equation jacobi(t₋, N)=m′. The data provider 10 then computes the value:

s₋≡(t₋−K/t₋)mod N

as the encrypted value of the bit m concerned.

The encrypted values s₊ and s₋ for each bit m′ of the user's data are then made available to the intended recipient 11, for example via e-mail or by being placed in an electronic public area; the identity of the trust authority 12 and the encryption key string 14 will generally also be made available in the same way.

The encryption key string 14 is passed to the trust authority 12 by any suitable means; for example, the recipient 11 may pass it to the trust authority or some other route is used—indeed, the trust authority may have initially provided the encryption key string. The trust authority 12 determines the associated private key B by solving the equation:

B²≡K mod N (“positive” solution)

If a value of B does not exist, then there is a value of B that is satisfied by the equation:

B²≡−K mod N (“negative” solution)

As N is a product of two prime numbers p, q it would be extremely difficult for any one to calculate the decryption key B with only knowledge of the encryption key string and N. However, as the trust authority 12 has knowledge of p and q (i.e. two prime numbers) it is relatively straightforward for the trust authority 12 to calculate B.

Any change to the encryption key string 14 will result in a decryption key 16 that will not decrypt the payload data 13 correctly. Therefore, the intended recipient 11 cannot alter the encryption key string before supplying it to the trust authority 12.

The trust authority 12 sends the decryption key to the data recipient 11 along with an indication of whether this is the “positive” or “negative” solution for B.

If the “positive” solution for the decryption key has been provided, the recipient 11 can now recover each bit m′ of the payload data 13 using:

m′=jacobi(s₊+2B,N)

If the “negative” solution for the decryption key B has been provided, the recipient 11 recovers each bit m′ using:

m′=jacobi(s₋+2B,N)

### SUMMARY OF THE INVENTION

According to one aspect of the present invention, there is provided a method of limiting a service to members of a group who are registered with a membership authority, wherein:

a provider of said service encrypts data based on encryption parameters comprising public data provided by the membership authority and an encryption key string, and the encrypted data is provided to a party;

to receive the service, said party must decrypt the encrypted data for which purpose it must obtain a decryption key from the membership authority;

the membership authority provides the decryption key to the party only if the latter is registered with the authority as a member of said group, the authority generating the decryption key in dependence on said encryption key string and private data related to said public data.

In this way, provided the service provider trusts the group membership authority, the party can prove to the service provider that the party is a member of said group without the party needing to disclose its identity to the service provider.

The service provider may be providing the service to the members of said group as a result of a prior arrangement with the group representatives. Alternatively, the service provider may be providing the service to any party meeting a particular condition, and the service provider may also have determined that, as that condition is a membership requirement of said group, anyone who is a group member is eligible to receive the service.

Preferably, the encryption key string is created in whole or in part by the service provider after receiving a service request; this ensures that the decryption key cannot be created in advance and therefore that the decryption key will only be available to the party if the latter's membership of the group is current.

The data encrypted by the service provider can be a data component of the service or arbitrary data which the service provider requires the party to decrypt and return before the service provider provides the service requested.

According to another aspect of the present invention, there is provided a system for limiting a service to members of a group who are registered with a membership authority, the system comprising:

a first computer entity associated with a provider of said service and arranged to encrypt data based on encryption parameters comprising public data provided by the membership authority and an encryption key string, and to provide the encrypted data to a party;

a second computer entity associated with said party and arranged to decrypt the encrypted data using a decryption key obtained from the membership authority; and

a third computing entity associated with the membership authority and comprising:

a membership-checking arrangement for checking whether said party is registered with the authority as a member of said group,

a key-generation arrangement for generating the decryption key in dependence on said encryption key string and private data related to said public data, and

a control arrangement for enabling the generation of the decryption key by the key-generation arrangement and/or the provision of the decryption key to the second computer entity, only if said party is a group member as checked by the membership-checking arrangement.

According to a further aspect of the present invention, there is provided a computing entity comprising:

a first data store for holding private data;

a second data store for holding membership data indicative of members of a group,

a membership-checking arrangement for checking whether a particular party is a member of said group,

a communications interface for receiving an encryption key string from a party requesting the corresponding decryption key, and for outputting the requested decryption key to the requesting party;

a decryption-key generation unit for using the private data and a received encryption key string to generate a corresponding decryption key for decrypting data encrypted using the encryption key string and public data derived using said private data;

a control arrangement for enabling the generation of the decryption key by the decryption-key generation arrangement and/or the provision of the decryption key to a said requesting party via said communications interface, only if that party is a group member as checked by the membership-checking arrangement.

### BRIEF DESCRIPTION OF THE DRAWINGS

Embodiments of the invention will now be described, by way of non-limiting example, with reference to the accompanying diagrammatic drawings, in which:

FIG. 1 is a diagram illustrating the operation of a prior art encryption schema known as Identifier-Based Encryption;

FIG. 2 is a diagram illustrating how certain IBE operations are implemented by three different prior art IBE methods; and

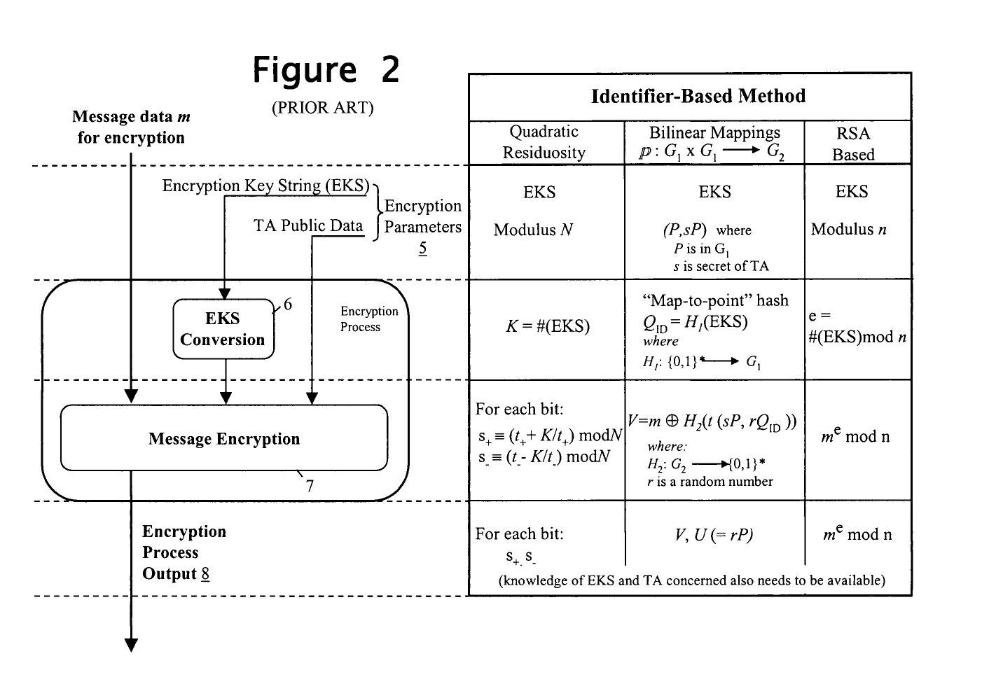

FIG. 3 is a diagram of an embodiment of the present invention.

### BEST MODE OF CARRYING OUT THE INVENTION

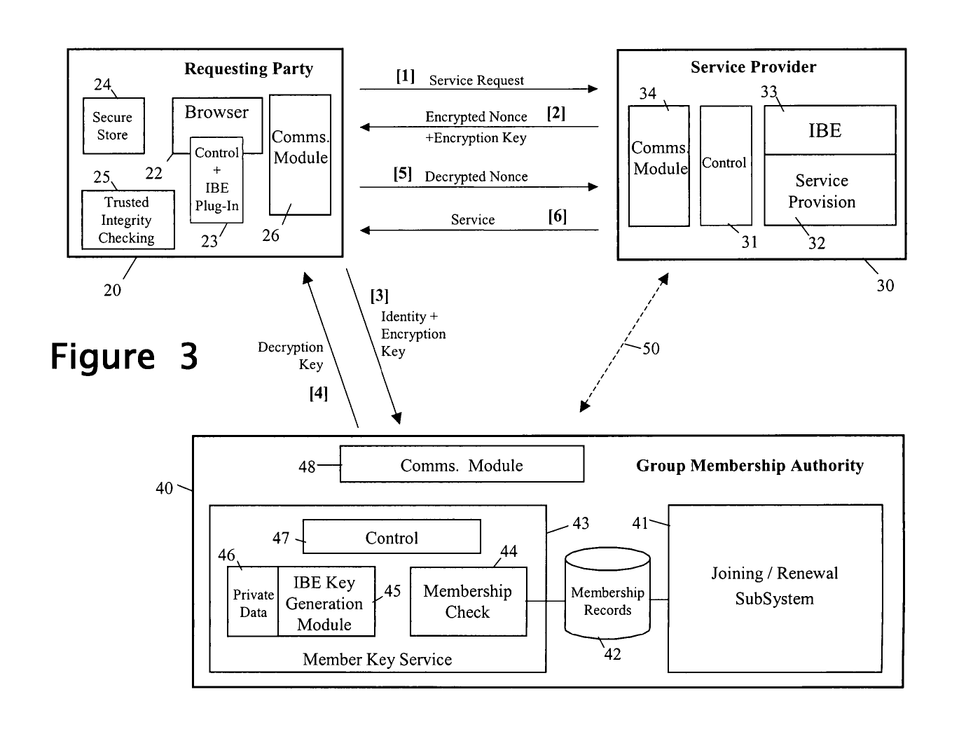

FIG. 3 illustrates a system in which a requesting party using a computing entity 20 is arranged to request a service from a service provider that is using a computing entity 30, the service only being provided if the requesting party can obtain a key to decrypt data provided in encrypted form by the service provider. The requesting party can obtain the required decryption key from a membership authority that is using a computing entity 40 if, and only if, the requesting party is registered as a member of a specific group with the membership authority. The group of which the requesting party must be a member is locked in by the service provider in the encryption variables it uses when encrypting the data sent in encrypted form to the requesting party entity 20. This is important as the service provider will typically have decided to provide the service to members of that particular group either because of a prior arrangement with representatives of the group or because the service provider wants to apply a condition of eligibility for the service that the service provider also knows is a membership requirement of that group. Of course, the service provider must trust the membership authority to correctly check group membership and to only provide decryption keys to group members.

The computing entities 20, 30 and 40 inter-communicate, for example, via the internet or other computer network though it is also possible that two or all three entities actually reside on the same computing platform.

In the following, references to the requesting party, service provider and membership authority are generally used interchangeably with references to their respective computing entities 20, 30, 40, though it will be appreciated that a group member will normally be a natural or legal person rather than the corresponding computing entity 20 (however, it is also possible that the entity 20 is itself a group member rather than a person).

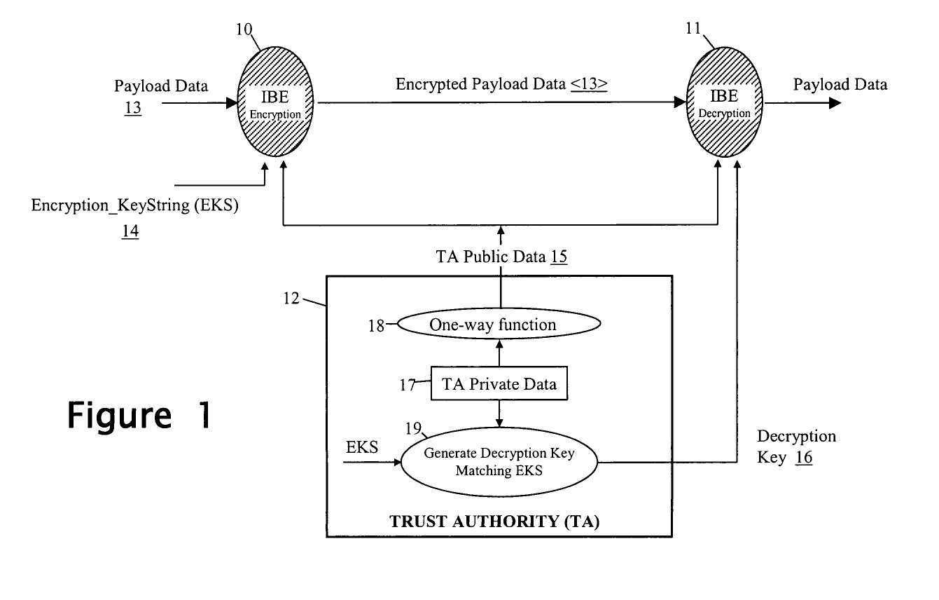

The FIG. 3 system employs Identifier-Based Encryption with the computing entities 20, 30 and 40 having roles (so far as the IBE cryptographic processes are concerned) corresponding to those of data recipient 11, the data provider 10, and trusted authority 12 of the FIG. 1 IBE arrangement. The IBE algorithm used is, for example, the QR algorithm described above with respect to FIG. 1.

Considering the FIG. 3 system in more detail, the requesting-party entity 20 comprises a browser 22 providing a user interface for managing interaction with the service-provider entity 30; a secure data store 24 holding identity data of the requesting party; a trusted integrity checking module 25; and a communications module 24 for communicating with the other entities 30, 40. The browser 22 has a plug-in 23 provided, for example, by the membership-authority entity 40. The plug-in provides both control functionality for coordinating the operations of the entity 20 to be described below, and the IBE functionality needed by the entity 20. Where the QR IBE method is being used, the plug-in 23 thus contains the public data N and program code for decrypting data using N and a decryption key provided by the membership-authority entity 40.

In the present example, the value of N (and thus also of p and q from which N was derived) is uniquely associated with the group whose members are registered with the membership-authority entity 40; more particularly, the group regulated by the membership-authority entity 40 is here taken to have an associated value of N equal to N₁. This value N₁ is the value contained in the plug-in 23 and is used below to designate the associated group.

The service-provider entity 30 comprises a control module 31 for controlling the operations, to be described below, that ensure service provision is limited to members of the group N₁; a service provision module 32 arranged to effect service provision as permitted by the control module 31; an IBE encryption module 33 (in the present example implementing the QR method and therefore employing N₁ and hash function #); and a communications module for communicating with the entities 20 and 40.

The membership-authority entity 40 comprises a communications module 48 for communicating with the entities 20 and 40; a membership joining/renewal subsystem 41; a membership database 42 holding membership records for the group N₁; and a member key service subsystem 43. The membership joining/renewal subsystem 41 is arranged to regulate the enrolment and membership renewal of parties wishing to become, or continue as, members of the group N₁. The subsystem 41 is therefore responsible for ensuring that applicants for membership (including membership renewal) meet any predetermined requirements for membership of the group N₁. The subsystem 41 can be an entirely electronic subsystem arranged to communicate via the communications module 48 with applicants for membership and any external trusted parties that the sub-system uses to check compliance by applicants with membership requirements. Alternatively, the sub-system can be partly or wholly manual with applicants for membership applying, for example, in person or via the postal service.

In the present example, the only link between the group membership sub-system 41 and the key service subsystem 43 is via the membership database 42. Indeed, the subsystems 41 and 43 can be entirely independent of each other except for this link and may, for example, be separately located and, indeed run by separate organisations. Thus, the key service subsystem 43 may be run by a specialist organisation acting on behalf of representatives of the group N₁ who themselves provide the membership joining/renewal subsystem 41.

As already noted, the service provider will typically have decided to provide the service to members of the group associated with the membership authority entity 40, either because of a prior arrangement with representatives of the group or because the service provider wants to apply a condition of eligibility for the service that the service provider also knows is a membership requirement of that group. To facilitate this latter situation, the group membership requirements are preferably published, or otherwise made available, to the service provider 20 (see dashed arrow 50). The value N₁ and the hash function # are also provided to the service provider entity 30 (this can be done in many possible ways, including by including it in a service request made to the service provider).

The member key services subsystem 43 comprises a membership check module 44, an IBE decryption key generation module 45, a memory 46 holding the private data from which the public data N₁ was derived, and a control module 47 for coordinating the functioning of the subsystem 43 to effect the operations to be described below. The membership check module 44 is operative to check whether a party requesting a decryption key from the regulating entity 40 is a current member of group N₁ as indicated by the membership database 42, this check preferably involving checking the identity of the party requesting the key. The key generation module 45 is operative to generate a decryption key matching an encryption key string supplied by the party requesting the decryption key; generation of the decryption key involves using both the encryption key string and the private data held in memory 46. The module 45 can be arranged to generate a decryption key either in advance of the membership check by module 44 or only upon completion of the latter; in the former case, the decryption key is not output until the membership check has been completed and has shown the requesting party to be a member of group N₁.

With respect to how the identity of a party requesting a decryption key is checked by the membership module 44, this can be done in a number of ways. For example, the requesting-party entity can send the key service subsystem 43 the identity information it holds in its secure store 24. This information is typically a secret which may either be known only to the party 20 and to the membership authority 40, or, preferably, a secret that is known only to the party 20 but which can be used by the party 20 in a manner proving that it possesses the secret. An example of the latter type of secret is the private key of a public/private key pair of an asymmetric cryptographic scheme; in this case, the membership check module 44 checks the identity of the party 20 by encrypting a nonce using the public key of the public/private key pair associated with the party 20 and sending the encrypted nonce to the party 20 with a request that it return the decrypted nonce (which the party 20 can only do if it holds the private key). The association between the public key and the identity of the party can be confirmed using certificates in standard manner; of course, where the key pair was issued by the regulating body 30, it will already know the association between public key and identity without the need for certificates. The foregoing is just one example of how the membership authority can check the identity of party 20 and any other secure entity authentication protocol can be used instead, such as one of the protocols described in ISO/IEC 9798 parts 2-5.

Of course, such identity checks rely on the party 20 not having communicated its secret to another party. For this reason, the secret is preferably held in a secure store with the entity 20 being a trusted platform that can be interrogated in a trustable manner to confirm that the secret is securely held. To this end, the secret can be the private key of a key pair held in protected storage associated with a TPM (trusted platform module) as described in:

TCPA—Trusted Computing Platform Alliance Main Specification v1.1, www.trustedcomputing.org, 2001.

Mechanisms suitable for enabling the membership check module 44 to assure itself that entity 20 is a trusted platform operating as expected are also described in the above document and are represented in FIG. 3 by the trusted integrity checking module 25.

Having described the components of entities 20, 30 and 40, a description will now be given of the process by which the requesting party gains access to a service available from the service provider if it is a member of group N₁. In the FIG. 3 embodiment, this process comprises the following steps:

[1] The party 20 makes a service request to the service provider 30. If the service provider offers more than one service, then the request identifies the service required. Where the requested service is offered to members of more than one group, the request also indicates the group of which the party 20 asserts it is a member (in this case, group N₁). The party 20 does not identify itself to the service provider 30.

[2] Upon the service request being received at the service provider, the control module 31 identifies the service requested and the group to which the requesting party asserts it belongs. The control module 31 then causes the IBE module 33 to encrypt an arbitrary message using both the public data N₁ and, as an encryption key string, a nonce (random number) or other unpredictable string. The control module 31 returns the encrypted message to the requesting party 20 together with the encryption key string used.

[3] The party 20, on receiving the encrypted message, temporarily stores the message and sends the associated encryption key string to the key service subsystem 43 of the membership authority 40 with a request for the corresponding decryption key.

[4] This request also includes the identity of the party 20. The control module 47 of the key service subsystem 43 now asks the membership check module 44 to check that the requesting party is a member of group N₁. In carrying out this check, the module 44 first confirms the identity of the party 20, for example, by using a challenge/response mechanism in which it sends a nonce encrypted with the public key corresponding to the presented identity; only if the nonce is successfully decrypted and returned by the party 20, does the module accept that the party 20 is who it claims to be. Any other suitable secure entity authentication protocol can be used instead of the foregoing identity check mechanism. Assuming the identity check is passed, the module 44 next accesses the membership database 42 to ascertain whether the party 20 is a current member of group N₁ The result of the membership check is reported by the module 44 to the control module 47. If current membership is not established, the control module 47 sends a refusal back to the requesting party 20. However, if the party 20 is found to be a current registered member of the group N₁ by the module 44, the control module 47 next asks the key generation module 45 to generate a decryption key to match the encryption key string provided by the party 40. This decryption key is then sent to the party 20 (preferably over a secure connection).

[5] The requesting party 20 uses the decryption key to decrypt the message previously received from the service provider 30. The decrypted message is then sent back to the service provider to prove that the party 20 is indeed a current member of group N₁.

[6] The control module 31 of the service-provider entity 30 checks that the decrypted message matches the original message and if this is case, then enables the service provision module 32 to proceed with provision of the service requested by the party 20.

In this way, the party 20 is authorised to receive the requested service without the party having to disclose its identity to the service provider 30 and without the service provider having to handle certificates. Instead, authorisation is effected by the party 20 proving it is a member of a group approved by the service provider 30 to receive the requested service. Furthermore, because the service provider 30 only generated the encryption key string at the time of receiving the service request, the service provider is assured of the currency of the requesting-party's membership of group N₁ (provided it trusts the membership authority 40 to check membership before sending the decryption key to the party 20).

In a variant of the FIG. 3 process, it is the requesting party that provides the encryption key string to the service party (for example as part of the request step [1]), the service provider then using this key to encrypt the data it sends to the requesting party in step [2]. With this approach, the requesting party can, in fact, obtain the decryption key either before or after the service provider carries out step [2]. One consequence of this is that if the requesting party obtains the key in advance of making a service request, the membership check made by the membership authority will not be up-to-date when the service request is made. This may or may not be of concern to the service provider. If it is likely to be a concern, then either the service provider must itself generate the encryption key string or else the encryption key string provided by the requesting party must include information, such as membership expiry date, that the membership authority is arranged to check before it generates the corresponding decryption key. If, for example, the encryption key string includes the membership expiry date and the membership authority checks this is correct and then provides the corresponding decryption key, the requesting party cannot subsequently change the expiry date information and still have an operative decryption key. It will be appreciated that any type of information can be passed to the service provider in this manner with the information being trustable to the extent that the membership authority has checked the information before providing the corresponding decryption key. Of course, the encryption key string can itself be provided by the membership authority; for example, the membership authority may provide a newly joining group member with a matching pair of encryption and decryption keys.

Another possibility regarding generation of the encryption key string would be to have the requesting party and service provider cooperate in the generation of the key string.

In another variant of the FIG. 3 process, the encrypted data sent by the service provider 30 to the requesting party (arrow [2] in FIG. 3) is a data component of the service, such as software or digital media content (the service being, in effect, the provision of such items in accessible form); the requesting party can only access (decrypt) and use the data component if that party is a registered member of said group. In this case, steps [5] and [6] will generally not be needed.

Possible applications of the above-described arrangement for limiting a service to members of a group include:

i). A company (the group N₁) has an arrangement with a software supplier (service provider 30) to provide software updates to any employees (each an eligible requesting party 20) of the company on demand. On receiving a request for a software update, the software supplier encrypts the update (using N₁) and returns the update. If the requesting party is an employee of the company concerned, the party can obtain the required decryption key from the membership authority appointed by the company (the company may run the authority itself).

ii) An individual wants to download a digital music recording from the Web into their portable player. The manufacturer of the player has an agreement with the music provider (service provider 20) for the latter to supply music free of charge to any individual who has purchased their player. The manufacturer accordingly establishes a group (group N₁) the registered members of which are the purchasers of the manufacturer's player. In one implementation, a purchaser subsequently requests music recordings over the internet which the music provider supplies in encrypted form, the purchaser then contacting the purchaser-group membership authority to obtain the appropriate decryption key (the membership authority may, for example, be run by the music provider on the basis of purchase information supplied by the manufacturer). An alternative implementation would be for encrypted music recordings to be preloaded into the player by the manufacturer, the purchaser then subsequently obtaining the decryption key after purchase. It should be noted that in this latter implementation, there is no specific request step [1].

iii) A teenager (party 20) wishes to purchase an 18+ digital video from a video store (service provider). The store is unsure of the teenager's age but the teenager claims to be a member of a local club (group N₁) having a membership condition of a minimum age of 18. The store therefore encrypts the video using the public data N₁ of the club thereby enabling the teenager to decrypt the video only if they are a member of the club as claimed. It may be noted that in this example, the store (service provider) is not concerned about the currency of the membership since once a person has reached 18 they thereafter will continue to satisfy the 18+ condition for viewing the video.

It will be appreciated that many other variants are possible to the above described embodiments of the invention. For example, instead of the QR IBE method, the above-described embodiments can be implemented using other, analogous, cryptographic methods such as IBE methods based on Weil or Tate pairings or are RSA based.

Whilst a service provider may limit a service to members of a particular group, the service provider can, of course, provide the service to members of other specific groups on the same basis unless the service provider has agreed with representatives of the first group that the service is to be provided exclusively to the members of the first group.

In the FIG. 3 embodiment, the membership authority 40 performed its role in respect of a single group. In fact, the membership authority can perform its role for multiple different groups. In particular, and without limitation, a single key service subsystem 43 can be arranged to provide its services in respect of multiple groups each of which has its membership regulated by a respective joining/renewal subsystem 41, the group membership records for each group either being held in a respective database 42 or in a single common database. Where the membership authority 40 is competent in respect of multiple groups, each group is assigned respective public/private data values (the parameters N and p, q in the FIG. 1 example of the QR IBE method), the party 20 then indicating the relevant group to the membership authority when requesting a decryption key. An alternative would be for the membership authority 40 to use a single set of public/private data values for all groups and then to have the service provider 30 encrypt the data sent to the party 20 (arrow [2] in FIG. 3) using an]BE encryption key string that comprises an identifier of the group of interest—the party 20 cannot successfully subvert the identity of the group for which membership checks are to be carried out because changing the encryption key string provided to the membership authority will result in an inoperative decryption key being returned.

Rather than the service provider limiting service provision to parties who can show that they are members of a single group (which may be one of several different group in respect of which the service provider is willing to provide its service), the service provider may instead decide to limit service provision to those parties who can each show that they belong to every group of a predetermined set of groups—the motivation for doing this is, for example, that the service provider wishes to ensure that the service is provided only to parties meeting multiple conditions each of which corresponds to a predetermined membership requirement of a different group. Assuming that each group of which a party must be a member in order to receive the service, has its members registered with an associated membership authority, the service provider ensures that service provision is restricted to parties who are members of all required groups by causing the party to have access to a decryption key in respect of each group; in other words, the service provider causes the membership checking process described above with respect to FIG. 3 (or any of the described variants) to be carried out for each group concerned using the appropriate public and private data. (N and p,q for the QR IBE method). This can be achieved in a number of ways; for example:

for each group of which the party is required to be a member to access the service, the service provider can encrypt a different item of data for sending to the requesting party using the public data associated with that group, the service provider only providing the service if the requesting party returns all the data items unencrypted;

the service provider organises the service as a number of data strings (say n strings, by using Shamir's secret sharing scheme) and then encrypts each string using the public data of a respective one of the membership authorities; in order to retrieve the service, the requesting party has to decrypt all of the strings—because any n−1 strings or less cannot disclose any information of the service.

the service provider can use the data encrypted in respect of one condition as the data to be encrypted in respect of the next condition, the encrypted data resulting from the encryption effected in respect of all said conditions then being sent to the requesting party for decryption in successive decryption operations. This can be expressed as:

Encryption: ciphertext=E{K_{—}MAn, E{K_{—}MAn−1, . . . E{K_{—}MA1, data} . . . }

Decryption: data=D{K′_{—}MA1, D{K′_MA2, . . . D{K′_{—}MAn, ciphertext} . . . }

where K_MAn is encryption key string used in relation to the membership authority MAn, K′_MAn is decryption key issued by MAn

the service provider can encrypt a data item using public data from each of the relevant groups, decryption of the encrypted item only being possible by obtaining a decryption sub-key in respect of each group from the corresponding membership authority. This can be expressed as:

Encryption: ciphertext=E(K_all, data)

Decryption: data=D(K_all, ciphertext)

where K_all is encryption key string related to all membership authorities, K′_all is the corresponding decryption; key K′_all is retrieved from all decryption sub-keys, each provided by a respective one of the membership authorities. Further information about how multiple trust authorities can be used is given in:

Chen L., K. Harrison, A. Moss, N. P. Smart and D. Soldera. “Certification of public keys within an identity based system” Proceedings of Information Security Conference 2002, ed. A. H. Chan and V. Gligor, LNCS 2433, pages 322-333, Springer-Verlag, 2002.

It will be appreciated that the membership authority associated with each required group may be different for all groups or may be the same for two or more of the groups.

1. A method of limiting a service to members of a group who are registered with a membership authority, wherein:
a provider of said service encrypts data based on encryption parameters comprising public data provided by the membership authority and an encryption key string, and the encrypted data is provided to a party;
to receive the service, said party must decrypt the encrypted data for which purpose it must obtain a decryption key from the membership authority;
the membership authority provides the decryption key to the party only if the latter is registered with the authority as a member of said group, the authority generating the decryption key in dependence on said encryption key string and private data related to said public data.

2. A method according to claim 1, wherein the encryption key string is created in whole or in part by the service provider.

3. A method according to claim 1, wherein the encryption key string is created in whole or in part by the service provider upon receipt of a service request from said party, the requesting party receiving the encryption key string from the service provider and providing it to the membership authority, and the membership authority only returning the decryption key after confirming that the party is a registered group member.

4. A method according to claim 1, wherein said party creates the encryption key string and provides it to the service provider when requesting said service, the party obtaining the decryption key from the membership authority either before or after requesting said service from the service provider.

5. A method according to claim 4, wherein the encryption key string is formed using information about at least one of said party and the membership authority, this information being used by the service provider in the process of determining whether to provide said service to said party.

6. A method according to claim 1, wherein the encryption and decryption keys are created by the membership authority and provided to said party on the latter becoming a registered member of said group.

7. A method according to claim 6, wherein the encryption key string is formed using information about at least one of said party and the membership authority, this information being used by the service provider in the process of determining whether to provide said service to said party.

8. A method according to claim 1, wherein the data that is encrypted by the service provider is a data component of the service, said party only being able to decrypt and use this data component if it is a registered member of said group.

9. A method according to claim 8, wherein the data component comprises at least one of software and digital media content.

10. A method according to claim 1, wherein the data that is encrypted by the service provider is arbitrary data, said party being required to decrypt and return this data as evidence of its membership of said group before the service provider provides said service to the party.

11. A method according to claim 1, wherein in order to obtain the decryption key from the membership authority, said party proves its identity to the membership authority by using a secure entity authentication protocol.

12. A method according to claim 11, wherein the entity authentication protocol uses a secret that is securely stored in a trusted computing platform the integrity of which is checked by the membership authority before it accepts the proof of identity provided by said party.

13. A method according to claim 1, wherein the membership authority checks that said party is a registered member of said group before generating said decryption key.

14. A method according to claim 1, wherein the cryptographic processes involving said encryption and decryption keys are identifier-based cryptographic processes utilising quadratic residuosity.

15. A method according to claim 1, wherein the cryptographic processes involving the said encryption and decryption keys are identifier-based cryptographic processes utilising Weil or Tate pairings.

16. A method according to claim 1, wherein multiple groups are registered with the membership authority with each group having respective associated said public and private data, the service provider encrypting the data to be provided to said party using the public data of the group to which the service provider requires that party to belong in order to receive the service, this group being identified to the membership authority to enable it to check the party's membership of that group and to provide the appropriate decryption key by using the private data associated with that group when generating the decryption key.

17. A method according to claim 1, wherein multiple groups are registered with the membership authority and the same said public and private data is used in respect of all groups, the service provider encrypting the data to be provided to the requesting party using an encryption key string formed using at least an identifier of the group to which the service provider requires that party to belong in order to receive the service, the membership authority determining from the encryption key string the group in respect of which it is to check the membership of said party before it provides the decryption key to that party.

18. A method according to claim 1, wherein the service provider provides the service to members of said group as a result of a prior arrangement with the group representatives.

19. A method according to claim 1, wherein the service provider provides the service to parties meeting a particular condition, the service provider providing the service to members of said group after having determined that said condition is a predetermined membership requirement of said group.

20. A method of enabling a service provider to limit service access to parties meeting multiple conditions each of which corresponds to a predetermined membership requirement of a different group whose members are registered with an associated membership authority, wherein the method of claim 1 is applied in to check each condition using the said public and private data appropriate for the group that has the corresponding membership requirement.

21. A method according to claim 20, wherein for each group of which the party is required to be a member to access the service, the service provider encrypts a different item of data to be provided to said party.

22. A method according to claim 20, wherein the data encrypted in respect of one condition is used as the data to be encrypted in respect of the next condition, the encrypted data resulting from the encryption effected in respect of all said conditions then being provided to the requesting party for decryption in successive decryption operations.

23. A method according to claim 20, wherein the service provider encrypts the data to be provided to said party using public data associated with each of the relevant groups, decryption of the encrypted item only being possible by obtaining a decryption sub-key in respect of each group from the corresponding membership authority.

24. A system for limiting a service to members of a group who are registered with a membership authority, the system comprising:
a first computer entity associated with a provider of said service and arranged to encrypt data based on encryption parameters comprising public data provided by the membership authority and an encryption key string, and to provide the encrypted data to a party;
a second computer entity associated with said party and arranged to decrypt the encrypted data using a decryption key obtained from the membership authority; and
a third computing entity associated with the membership authority and comprising:
a membership-checking arrangement for checking whether said party is registered with the authority as a member of said group,
a key-generation arrangement for generating the decryption key in dependence on said encryption key string and private data related to said public data, and
a control arrangement for enabling the generation of the decryption key by the key-generation arrangement and/or the provision of the decryption key to the second computer entity, only if said party is a group member as checked by the membership-checking arrangement.

25. A system according to claim 24, wherein the encryption key string is created in whole or in part by the first computer entity.

26. A system according to claim 24, wherein the first computer entity is arrange to create, or at least participate in the creation of, said encryption key string upon receipt of a service request from said party, the second computer entity being arranged to receive the encryption key string from the first computer entity and to provide it to said third computer entity to enable the latter to generate and return the decryption key after confirming that said party is a group member.

27. A system according to claim 24, wherein the second computer entity is arranged to create the encryption key string and provide it to the first computer entity when requesting said service, the second computer entity being further arranged to obtain the decryption key from the third computer entity either before or after requesting said service from the first computer entity.

28. A method according to claim 27, wherein the encryption key string is formed using information about at least one of said party and the membership authority, the first computer entity being arranged to use this information in the process of determining whether to provide said service to the party.

29. A system according to claim 24, wherein the third computer entity is arranged to generate the encryption and decryption keys and to provide them to the second computer entity on said party becoming a registered member of said group.

30. A method according to claim 29, wherein the encryption key string is formed using information about at least one of said party and the membership authority, the first computer entity being arranged to use this information in the process of determining whether to provide said service to the party.

31. A system according to claim 24, wherein the data that is encrypted by the first computer entity is a data component of the service, the second computer entity only being able to decrypt and use this data component if said party is a registered member of said group.

32. A system according to claim 31, wherein the data component comprises at least one of software and digital media content.

33. A system according to claim 24, wherein the data that is encrypted by the first computer entity is arbitrary data, the first computer entity being arranged to require the second computer to decrypt and return this data as evidence of its membership of said group before the first computer entity provides said service.

34. A system according to claim 24, wherein in order to obtain the decryption key from the membership authority, the second computer entity is arranged to prove its identity to the third computer entity by using a secret.

35. A system according to claim 34, wherein the second computer entity is a trusted computer platform with secure storage for storing said secret, the third computer entity being arranged to check the integrity of the second computer platform before accepting the proof of identity provided by the latter.

36. A system according to claim 24, wherein the cryptographic processes effected by the first, second and third computer entities in respect of the said encryption and decryption keys are identifier-based cryptographic processes utilising quadratic residuosity.

37. A system according to claim 24, wherein the cryptographic processes effected by the first, second and third computer entities in respect of the said encryption and decryption keys are identifier-based cryptographic processes utilising Weil or Tate pairings.

38. A computing entity comprising:
a first data store for holding private data;
a second data store for holding membership data indicative of members of a group,
a membership-checking arrangement for checking whether a particular party is a member of said group,
a communications interface for receiving an encryption key string from a party requesting the corresponding decryption key, and for outputting the requested decryption key to the requesting party;
a decryption-key generation unit for using the private data and a received encryption key string to generate a corresponding decryption key for decrypting data encrypted using the encryption key string and public data derived using said private data;
a control arrangement for enabling the generation of the decryption key by the decryption-key generation arrangement and/or the provision of the decryption key to a said requesting party via said communications interface, only if that party is a group member as checked by the membership-checking arrangement.
